(19) United States
(12) Patent Application Publication
(10) Pub. No.: US 2016/0205118 A1
(43) Pub. Date: Jul. 14, 2016

(54) CYBER BLACK BOX SYSTEM AND METHOD THEREOF

(71) Applicant: ELECTRONICS AND TELECOMMUNICATIONS RESEARCH INSTITUTE, Daejeon (KR)

(72) Inventor: Jong Hyun KIM, Daejeon (KR)

(21) Appl. No.: 14/937,498

(22) Filed: Nov. 10, 2015

(30) Foreign Application Priority Data
Jan. 13, 2015 (KR) 10-2015-0006016

(51) Int. Cl. H04L 29/06; H04L 12/743

(52) U.S. Cl. CPC H04L 63/1416; H04L 45/7453

(57) ABSTRACT

Provided is a cyber black box system. The cyber black box system includes a data collector configured to collect entire packet data, flow data, and a portable executable (PE) file from monitored network traffic and a server configured to analyze a cause of a cyber intrusion event and reproduce the cyber intrusion event, based on the collected entire packet data, flow data, and PE file.

### CROSS-REFERENCE TO RELATED APPLICATIONS

This application claims priority under 35 U.S.C. §119 to Korean Patent Application No.10-2015-0006016, filed on Jan. 13, 2015, the disclosure of which is incorporated herein by reference in its entirety.

### TECHNICAL FIELD

The present invention relates to a cyber black box system and a method thereof, and more particularly, to a cyber black box system and a method thereof, which analyze a cause of a cyber intrusion event and collect evidence data of the cyber intrusion event.

### BACKGROUND

In the network security field, a cyber intrusion event denotes a case of attacking an information communication network and a system associated with the information communication network in a way such as hacking, a computer virus, a logic bomb, a mail bomb, and etc.

In the related study, since analysis is mainly used as an action against a cyber intrusion event, there are limitations in quick cause analysis and post-action. In addition, since there is no log information necessary for analyzing an attack cause after the cyber intrusion event occurs, it is difficult to analyze the attack cause. That is, since it is unable to know an attack cause even after an intrusion event is recognized, there is a limitation in a post-action.

Moreover, in an advanced cyber attack such as advanced persistent threats, several months or more are expended in only analyzing a cause, and it is difficult to find the cause with conventional security equipment.

### SUMMARY

Accordingly, the present invention provides a cyber black box system and a method thereof, which quickly analyze a cause of an intrusion event when the intrusion event occurs, and provide a function of collecting evidence data of the intrusion event.

In one general aspect, a method of collecting evidence data of a cyber intrusion event includes: extracting entire packet data from monitored network traffic; analyzing the extracted entire packet data based on an Internet protocol (IP), a port, and a protocol to extract, as flow data, a bundle of packet data having the same feature; extracting, as a portable executable (PE) file, a bundle of packet data having a PE format from the extracted entire packet data; temporarily storing in a buffer, and collecting the extracted entire packet data, flow data, and PE file; applying a hash function to each of the temporarily stored entire packet data, flow data, and PE file to generate a hash value; and storing, as the evidence data, the generated hash value and the temporarily stored entire packet data, flow data, and PE file in a storage unit.

In another general aspect, a cyber black box system, which collects evidence data of a cyber intrusion event and analyzes a cause of the cyber intrusion event, based on the collected evidence data, includes: a data collector configured to collect entire packet data, flow data, and a portable executable (PE) file from monitored network traffic; and a server configured to analyze the cause of the cyber intrusion event and reproduce the cyber intrusion event, based on the collected entire packet data, flow data, and PE file.

Other features and aspects will be apparent from the following detailed description, the drawings, and the claims.

### BRIEF DESCRIPTION OF THE DRAWINGS

FIG. 1 is a block diagram schematically illustrating an internal configuration of a black box system according to an embodiment of the present invention.

FIG. 2 is a diagram schematically illustrating evidence data collected by a data collector illustrated in FIG. 1.

FIG. 3 is a block diagram schematically illustrating an internal configuration of the data collector illustrated in FIG. 1.

FIG. 4 is a block diagram schematically illustrating an internal configuration of a server illustrated in FIG. 1.

FIG. 5 is a flowchart illustrating an operation of collecting and storing, by the data collector of FIG. 1, preservation data included in evidence data.

### DETAILED DESCRIPTION OF EMBODIMENTS

The advantages, features and aspects of the present invention will become apparent from the following description of the embodiments with reference to the accompanying drawings, which is set forth hereinafter. The present invention may, however, be embodied in different forms and should not be construed as limited to the embodiments set forth herein. Rather, these embodiments are provided so that this disclosure will be thorough and complete, and will fully convey the scope of the present invention to those skilled in the field.

The terms used herein are for the purpose of describing particular embodiments only and are not intended to be limiting of example embodiments. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Hereinafter, embodiments of the present invention will be described in detail with reference to the accompanying drawings.

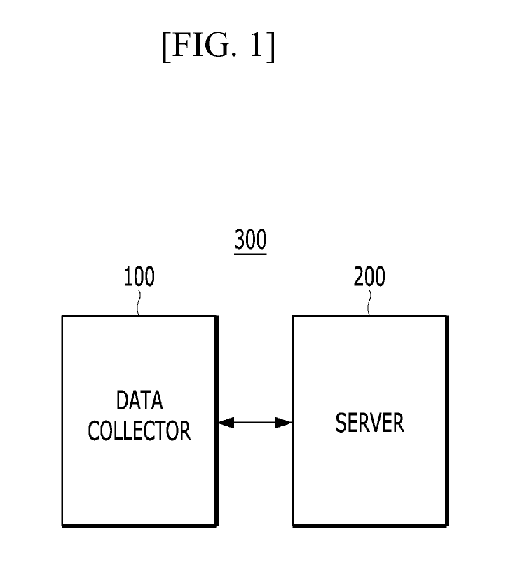

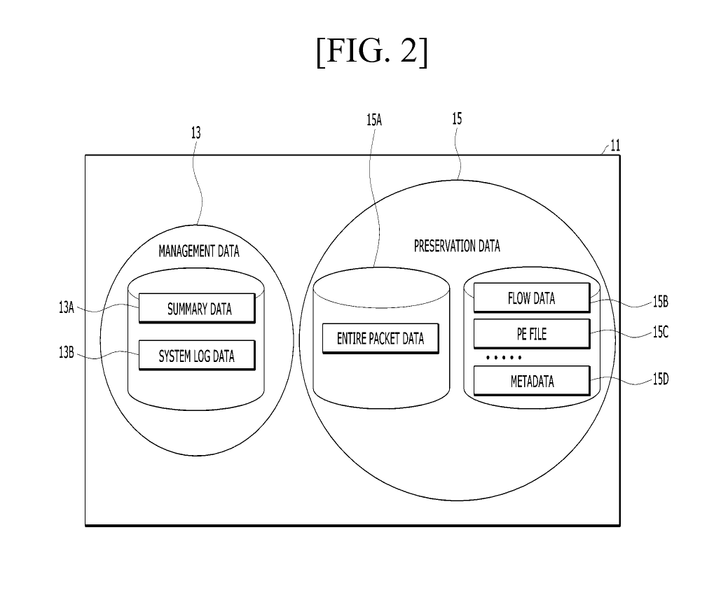

FIG. 1 is a block diagram schematically illustrating an internal configuration of a black box system 300 according to an embodiment of the present invention, and FIG. 2 is a diagram schematically illustrating evidence data collected by a data collector illustrated in FIG. 1.

Referring to FIG. 1, the black box system 300 according to an embodiment of the present invention may include a data collector 100, which collects evidence data (11 in FIG. 2), and a server 200 that analyzes a cause of a cyber intrusion event by using the evidence data collected by the data collector 100 and reproduces the cyber intrusion event, based on a result of the analysis.

The evidence data 11 collected by the data collector 100, as illustrated in FIG. 2, may include management data 13 and preservation data 15.

The management data 13 may include summary data 13A, generated by indexing the preservation data 15, and system log data 13B representing a resource state of the data collector 100.

The preservation data 15 may be data which is set to be preserved by the data collector 100 for a long time unlike the management data 13. The preservation data 15 may include entire network packet data (hereinafter referred to as entire packet data) 15A constituting the network traffic, flow data 15B extracted from the entire packet data 15A, a portable executable (PE) file 15C extracted from the entire packet data 15A, and metadata 15D associated with the PE file 15C. In this case, the preservation data 15 may further include a plurality of hash values for respectively ensuring the entire packet data 15A, and the flow data 15B, the PE file 15C. Here, the PE file 15C is an execution file executed by a window operating system (OS) and may include, for example, extensions such as x.cp, x.exe, x.dll, x.ocx, x.vxd, x.sys, x.scr, x.drv, and/or the like.

When a cyber intrusion event occurs, the server 200 may request the evidence data 11, collected by the data collector 100, from the data collector 100. Also, by using the evidence data 11 transferred from the data collector 100, the server 200 may analyze a cause of the intrusion event and may reproduce a cyber attack causing the intrusion event.

Moreover, the server 200 may supply an analysis result of the cause of the intrusion event to an external cyber security monitoring and control system (not shown).

Hereinafter, the data collector 100 illustrated in FIG. 1 will be described in detail.

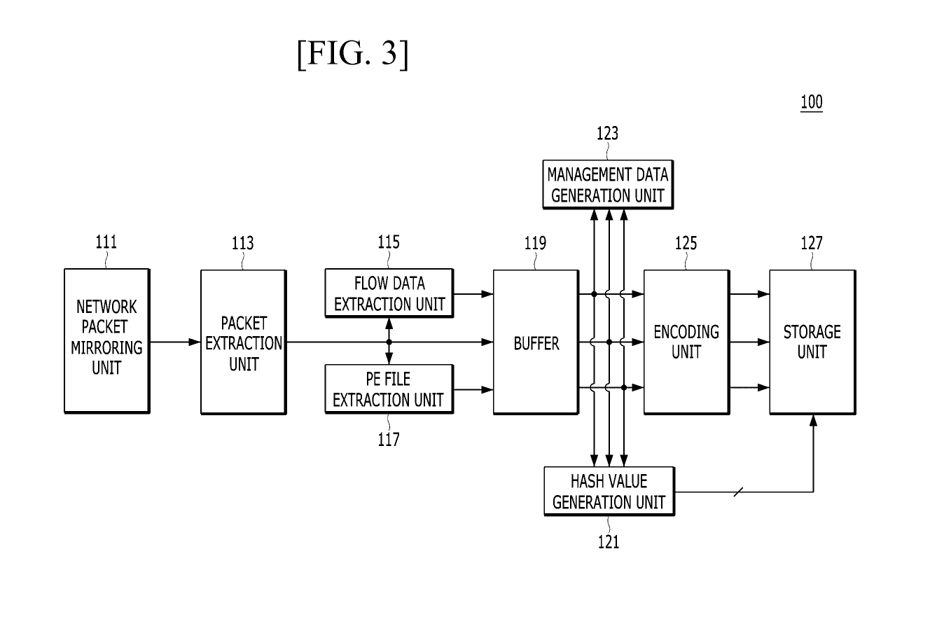

FIG. 3 is a block diagram schematically illustrating an internal configuration of the data collector 100 illustrated in FIG. 1.

Referring to FIG. 3, the data collector 100 according to an embodiment of the present invention may include a network packet mirroring unit 111, a packet extraction unit 113, a flow data extraction unit 115, a PE file extraction unit 117, a buffer 119, a hash value generation unit 121, a management data generation unit 123, an encoding unit 125, and a storage unit 127.

The network packet mirroring unit 111 is an element for monitoring (or copying) network traffic and may be network communication equipment such as a network interface card (NIC) or the like.

The network packet mirroring unit 110 may monitor the network traffic by using packet mirroring. The packet mirroring may be referred to as port mirroring. The port mirroring may denote copying all network traffic, seen from an arbitrary one port of the NIC, to another monitoring port of the NIC.

The packet extraction unit 113 may extract entire packet data from the network traffic copied by the network packet mirroring unit 110. The extracted entire packet data may be temporarily stored in the buffer 119. In this case, the extracted entire packet data may be bundled in a specific file form and may be temporarily stored in the buffer 119 in units of a certain time. Here, the specific file form may be a file having a packet capture (PCAP) format.

The flow data extraction unit 115 may extract flow data from the entire packet data extracted by the packet extraction unit 113.

A method of extracting the flow data may analyze all packet data extracted by the packet extraction unit 113, based on an Internet protocol (IP), a port, and a protocol, may collect packet data having the same feature in units of a certain time, based on a result of the analysis, and may bundle the packet data, collected in units of the certain time, in a specific file having the PCAP format to extract one piece of flow data (or a flow packet).

Another method of extracting the flow data may extract the flow data by sampling a certain-rate packet of entire packet data in a deterministic packet sampling scheme.

The extracted flow data may be temporarily stored in the buffer 119.

The PE file 117 may extract the PE file from the entire packet data extracted from the packet extraction unit 113. For example, the PE file extraction unit 117 may select packets having PE file information (or a PE format) in the entire packet data extracted by the packet extraction unit 113, may collect all packets having the selected PE file information, and may reassemble (or reconfigure) all the collected packets having the PE file information to one PE file, thereby extracting the PE file. The extracted PE file may be temporarily stored in the buffer 119. Also, the PE file extraction unit 117 may generate metadata corresponding to the extracted PE file.

The hash value generating unit 121 may apply a hash function to each of the entire packet data, the flow data, and the PE file to generate a hash value, for ensuring data integrity of each of the entire packet data, the flow data, and the PE file which are stored in the buffer 119. The generated hash value may be stored in the storage unit 127 and may be preserved for a long time.

The management data generation unit 123 may generate management data that includes the summary data and the system log data illustrated in FIG. 2.

The summary data is data generated by summarizing the entire packet data, the flow data, and the PE file which are classified as the preservation data illustrated in FIG. 2. For example, when a generation time or a detection time of each of entire packet data, flow data, and a PE file which are estimated as a cyber attack and an IP address, the entire packet data, the flow data, and the PE file which are estimated as the cyber attack are each stored in the form of files, the summary data may include file name information.

The summary data may be transferred to the sever 200 and may be used as statistical information. When the summary data is used as the statistical information, the statistical information may be used as information for visually providing an abnormal/harmful traffic generation condition and state to a user through a graphic user interface (GUI) included in the server 200. Also, in an operation where the server 200 searches for entire packet data, flow data, and a PE file, the summary data may be used as an indexing value for searching for relevant materials.

The system log data is data representing a system state of the data collector 100, and for example, may denote data representing a use rate of a central processing unit (CPU), a memory, and a disk which configure the data collector 100.

The management data including the summary data and the system log data may be periodically reported according to a request of the server 200. A report period may be set by the server 200.

The encoding unit 125 may encode the entire packet data, the flow data, and the PE file which are stored in the buffer 119 as a file having the PCAP format.

The storage unit 127 may store the entire packet data, the flow data, and the PE file, which are encoded by the encoding unit 125 in units of a file, as the preservation data.

Moreover, the storage unit 127 may receive the hash value, generated by the hash value generation unit 121, for each of the entire packet data, the flow data, and the PE file and may store the received hash value as evidence data.

Moreover, the storage unit 127 may be a storage that supports a write once read many (WROM) function. It can be understood that the storage unit 127 supporting the WORM function is a storage medium in which data is written once and from which the data is read a plurality of times like CD-ROMs. Therefore, the storage unit 127 may preserve the entire packet data, the flow data, and the PE file for a long time.

The entire packet data, the flow data, and the PE file which are stored in the storage unit 127 and are encoded in units of a file may be supplied to the server 200 according to a request of the server 200. That is, when an intrusion event occurs or another necessary case occurs, the encoded entire packet data, flow data, and PE file may be supplied to the server 200 as evidence data including at least one of the management data and the preservation data, for analyzing a cause of the intrusion event and reproducing the intrusion event.

Hereinafter, the server 200 illustrated in FIG. 1 will be described in detail.

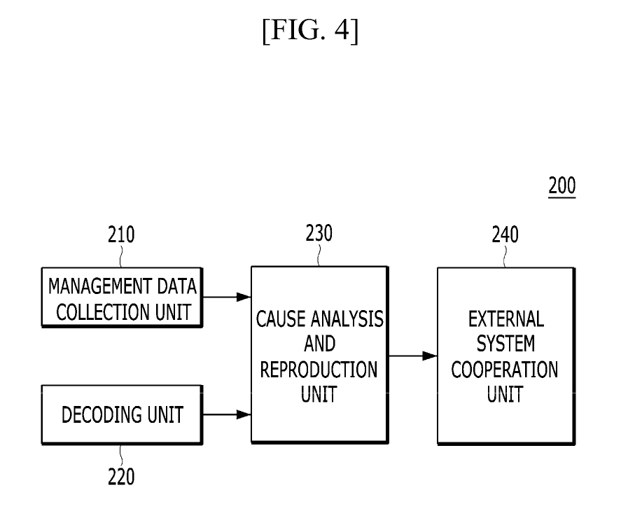

FIG. 4 is a block diagram schematically illustrating an internal configuration of the server 200 illustrated in FIG. 1.

Referring to FIG. 4, by using the evidence data supplied from the data collector 100, the server 200 may analyze a cause of an intrusion event and may reproduce the intrusion event.

To this end, the server 200 may include a management data collection unit 210, a decoding unit 220, a cause analysis and reproduction unit 230, and an external system cooperation unit 240.

The management data collection unit 210 may collect management data which is supplied from the data collector 100 according to a request of the cause analysis and reproduction unit 230 for the management data. In this case, the data collector 100 may periodically supply the management data to the management data collection unit 210 according to a predetermined report period without a request of the management data collection unit 210.

The decoding unit 220 may receive and decode the entire packet data, the flow data, and the PE file, which are stored (or preserved) in the storage unit 127 in an encoded state, and the metadata associated with the PE file.

The cause analysis and reproduction unit 230 may request preservation data and management data from the data collector 100. Here, the preservation data may include the decoded entire packet data, flow data, PE file, and metadata associated with the PE file, and the management data may include summary data and system log data.

In detail, the cause analysis and reproduction unit 230 may access the storage unit 127 of the data collector 100 to search for preservation data indexed to the summary data. When the preservation data is found, the cause analysis and reproduction unit 230 may request the found preservation data from the data collector 100.

When the found preservation data is received according to the request, the cause analysis and reproduction unit 230 may analyze a cause of an intrusion event by using the received preservation data and may reproduce a cyber attack causing the intrusion event.

The cause analysis and reproduction unit 230 may provide, as various pieces of visual information, an analysis result of the cause of the intrusion event to a user through a GUI.

A method of reproducing the cyber attack may extract a cyber attack scenario (for example, an attack time, an IP address where the cyber attack is performed, and/or the like), based on evidence data which is collected at a cyber attack time, may reconstruct the cyber attack scenario, based on extracted information, and may reproduce a corresponding intrusion event according to the reconstructed attack scenario.

The analysis result of the cause of the intrusion event may be supplied to an external system through the external cooperation system 240. The supply of the analysis result of the cause may be limited in order for the analysis result of the cause to be supplied to an authenticated external system. That is, the external cooperation system 240 may set a security grade in an external system and may give an appropriate authority to the external system according to the set security grade. The external system may be a security-related system provided in a security company, a public institution, a portal company, a general company, and/or the like.

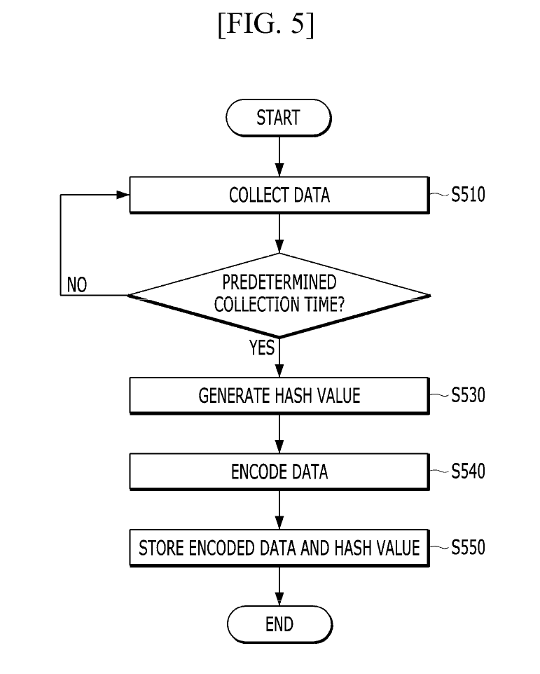

FIG. 5 is a flowchart illustrating an operation of collecting and storing, by the data collector 100 of FIG. 1, preservation data included in evidence data.

Referring to FIG. 5, first, the packet extraction unit 113 may perform a data collection operation of collecting evidence data from network traffic monitored by the packet mirroring unit 111 in step S510, and the collected evidence data may be temporarily stored in the buffer 119. Here, the evidence data may include entire packet data, flow data, and a PE file.

Subsequently, in step S520, the data collector 100 may determine whether a collection time of the evidence data stored in the buffer 119 satisfies a predetermined collection time.

When it is determined that the collection time of the evidence data satisfies the predetermined collection time, the data collector 100 may proceed to subsequent step S530. When it is determined that the collection time of the evidence data does not satisfy the predetermined collection time, the data collector 100 may continuously collect the evidence data until the collection time of the evidence data satisfies the predetermined storage time. When the collection time of the evidence data is set to one minute, the evidence data which is collected in real time may be bundled in the buffer 119 in units of one minute. A bundle of the evidence data which is bundled in units of one minute may be stored as a specific file having the PCAP format.

Subsequently, in step S530, the data collector 100 may generate a hash value for ensuring data integrity of the evidence data which is collected for the predetermined collection time.

Subsequently, in step S540, the data collector 100 may encode the evidence data, which is collected for the predetermined collection time, in units of the specific file.

Subsequently, in step S550, the encoded evidence data and the generated hash value may be preserved in the storage unit 127 supporting the WORM function.

Subsequently, when data to be processed is not stored in the buffer 119, a series of processes associated with an operation of collecting and storing preservation data included in the evidence data may be terminated.

In the embodiment of FIG. 5, the operation of collecting and storing the preservation data of FIG. 2 has been described above. However, the collecting and storing operation of FIG. 5 may be identically applied to the management data of FIG. 2 depending on a design.

As described above, in a related art action against a cyber attack, since several months or more are expended in only analyzing a cause of an intrusion event and there is no information necessary for analyzing an attack cause, it is unable to know the attack cause even after the intrusion event. However, according to the embodiments of the present invention, entire packet data, flow data, and a PE file may be collected as evidence data from network traffic and may be stored in the storage medium for a long time, and thus, a cause of an intrusion event is quickly analyzed based on the evidence data preserved in the storage medium.

According to the embodiments of the present invention, since evidence data collected from network traffic is preserved for a long time and integrity of the collected evidence data is secured, limitations of a related art action technology against a cyber attack are overcome, evidence data of an intrusion event is collected, and a cause is quickly analyzed.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A method of collecting evidence data of a cyber intrusion event, the method comprising:
extracting entire packet data from monitored network traffic;
analyzing the extracted entire packet data based on an Internet protocol (IP), a port, and a protocol to extract, as flow data, a bundle of packet data having the same feature;
extracting, as a portable executable (PE) file, a bundle of packet data having a PE format from the extracted entire packet data;
temporarily storing, in a buffer, and collecting the extracted entire packet data, flow data, and PE file;
applying a hash function to each of the temporarily stored entire packet data, flow data, and PE file to generate a hash value; and
storing, as the evidence data, the generated hash value and the temporarily stored entire packet data, flow data, and PE file in a storage unit.

2. The method of claim 1, wherein the collecting comprises storing the extracted entire packet data, flow data, and PE file in the buffer in units of a predetermined collection time.

3. The method of claim 1, wherein the bundle of the packet data is a file having a packet capture (PCAP) format.

4. The method of claim 3, further comprising: encoding the extracted entire packet data, flow data, and PE file which are temporarily stored in the buffer,
wherein the encoding comprises encoding the extracted entire packet data, flow data, and PE file in units of the file.

5. The method of claim 1, wherein the storing comprises storing the evidence data in the storage unit that supports a write once read many (WORM) function.

6. The method of claim 1, wherein the storing comprises further storing metadata of the PE file in the storage unit.

7. A cyber black box system that collects evidence data of a cyber intrusion event and analyzes a cause of the cyber intrusion event, based on the collected evidence data, the cyber black box system comprising:
a data collector configured to collect entire packet data, flow data, and a portable executable (PE) file from monitored network traffic; and
a server configured to analyze the cause of the cyber intrusion event and reproduce the cyber intrusion event, based on the collected entire packet data, flow data, and PE file.

8. The cyber black box system of claim 7, wherein the data collector comprises:
a packet extraction unit configured to extract the entire packet data from the monitored network traffic;
a flow data extraction unit configured to analyze the extracted entire packet data based on an Internet protocol (IP), a port, and a protocol to extract, as flow data, packet data having the same feature;
a PE file extraction unit configured to extract, as the PE file, packet data having a PE format from the extracted entire packet data; and
a storage unit configured to store the entire packet data, the flow data, and the PE file as the evidence data.

9. The cyber black box system of claim 8, further comprising: an encoding unit configured to encode the extracted entire packet data, flow data, and PE file,
wherein the storage unit stores the encoded entire packet data, flow data, and PE file.

10. The cyber black box system of claim 8, wherein the storage unit is a storage medium configured to support a write once read many (WORM) function.

11. The cyber black box system of claim 8, further comprising: a buffer configured to temporarily store the extracted entire packet data, flow data, and PE file in units of a certain collection time.

12. The cyber black box system of claim 11, wherein the storage unit stores the entire packet data, the flow data, and the PE file which are temporarily stored in the buffer in units of the certain collection time.

13. The cyber black box system of claim 8, wherein the storage unit stores the entire packet data, the flow data, and the PE file as a file having a packet capture (PCAP) format.

14. The cyber black box system of claim 8, further comprising: a hash value generation unit configured to apply a hash function to each of the extracted entire packet data, flow data, and PE file to generate a hash value thereof.

15. The cyber black box system of claim 14, wherein the storage unit stores the hash value as the evidence data.
